(19) United States
(12) Patent Application Publication
(10) Pub. No.: US 2004/0252931 A1
(43) Pub. Date: Dec. 16, 2004

(54) Multilayer monolithic electronic device and method for producing such a device

(76) Inventors: Marc Belleville, St. Egreve (FR); Emmanuel Hadji, Fontaine (FR); Bernard Aspar, Rives (FR)

Correspondence Address: Robert E Krebs, Thelen Reid & Priest, P O Box 640640, San Jose, CA, 95164-0640, US

(21) Appl. No.: 10/495,313

(22) PCT Filed: Nov. 13, 2002
(86) PCT No.: PCT/FR02/03880

(30) Foreign Application Priority Data
Nov. 15, 2001 (FR) 01/14784

(51) Int. Cl. G02B 6/12

(52) U.S. Cl. 385/14

(57) ABSTRACT

The invention relates to a multilayer monolithic electronic device comprising at least one first layer (46) capable of conveying information in an electrical form, arranged above at least one second layer (43) capable of conveying information in an optical form, and electrical and/or optical connection means.

### FIELD OF THE INVENTION

The present invention relates to a multilayer monolithic electronic device and to a method for producing such a device.

### PRIOR ART

In multilayer monolithic electronic devices, which nowadays constitute integrated circuits, the interconnects are a limiting step in respect of increasing their performance.

Current technological developments are aiming to reduce as far as possible the delay of the signals conveyed in these interconnects, and to minimize the power dissipated in them. Copper, which has a lower resistivity than aluminium, is now being used to replace the latter in interconnects. Insulators with a lower dielectric constant are likewise being introduced as a replacement for traditional silicon oxides. The gain provided by such developments, however, is still limited.

In parallel with these developments, predictions relating to the operating frequencies of future integrated circuits are continuing to increase unabated: 10 GHz has been reported in the short term for clocks.

In order to produce fast, relatively long-distance interconnects in such future integrated circuits, as described in the document referenced [1] at the end of the description, the use of optical interconnects has been envisaged, for example in structures based on SOI substrates (“silicon-on-insulator”). Two avenues of research are currently being pursued: producing the optical interconnects at the end of circuit fabrication, above metal layers, or alternatively producing the optical guides in the silicon, next to the transistors. The first solution has the drawback of encumbering the upper interconnect planes and therefore making it more difficult to supply power in the circuit. The second solution, when there are a large number of optical interconnects, very significantly degrades the integration density of the circuit.

It is an object of the invention to overcome these drawbacks of the prior art solutions.

### SUMMARY OF THE INVENTION

The present invention relates to a multilayer monolithic electronic device comprising means for connection between at least two layers, characterized in that it includes at least one first layer capable of conveying information in an electrical form, arranged above at least one second layer capable of conveying information in an optical form, and in that the connection means are electrical and/or optical means.

The first layer capable of conveying information in an electrical form comprises at least one electronic component, and the second layer capable of conveying information in an optical form comprises at least one optical guide. One of the layers may be made of a material selected from Si, AsGa, InP and their alloys. Each optical guide is a high-index homogeneous region contained between lower-index regions. The device may comprise patterns fulfilling functions of the mechanical pillar or sealing type and providing a surface capable of accommodating the upper layers. The spaces between the patterns and/or around the optical guide are filled with air, vacuum, inert gas or material with a low refractive index. Each optical guide may be a guide based on a photonic band gap structure which is filled with air, vacuum, inert gas or a material with a refractive index lower than that of the material guiding the light.

In one embodiment, the second layer capable of conveying information in an optical form comprises coupling means, and the first layer capable of conveying information in an electrical form comprises at least one active optical element, the coupling means making it possible to obtain coupling between at least one optical guide and at least one active optical element. The coupling means may be a reflection coupler or a diffraction coupler. The second layer may comprise at least one active optical element, and the connection means may be electrical means between this element and the first layer.

The device preferably has optical inputs/outputs.

In contrast to the prior art devices, which disclose either electrical connections or optical connections which may be juxtaposed on the same circuit or superimposed in separate circuits assembled together, the solution advocated by the device of the invention hence consists, in an electronic circuit, in relocating some of the electrical connections to another embedded layer and in converting them to optical connections. Such a solution makes it possible to alleviate the surface connections and improve the performance by changing over to the optical field.

The present invention also relates to a method for producing a multilayer monolithic electronic device, characterized in that it includes the following steps:

producing at least one optical guide in a first layer,

assembling the silicon substrate thus covered with a second layer,

producing electronic components in the second layer.

The assembling may be carried out by molecular adhesion.

The method may furthermore include a step of fabricating at least one active optical element and/or optical coupling means in the first layer.

The method may furthermore include a step of fabricating at least one active optical element in the second layer; the high-index region of the optical guide may be obtained by etching; the low-index region of the optical guide may be obtained by oxidation; the difference between the optical indices of the optical guide may be obtained by doping.

An active optical element may also be put into a holding cavity.

The layers may be SOI layers attached to a silicon substrate.

### BRIEF DESCRIPTION OF THE DRAWINGS

FIGS. 1, 2 and 3 illustrate optical guides which may be used in the device of the invention, after they have been produced in a first SOI layer and before an upper second SOI layer is attached, namely monocrystalline silicon guides surrounded by an SiO₂ insulator, etched monocrystalline guides, and monocrystalline silicon guides based on photonic band gap structures, respectively.

FIGS. 4, 5 and 6 illustrate the device of the invention in which optical coupling means are produced in the first SOI layer, respectively with the aid of an arbitrary coupler, with the aid of a reflection coupler, and with the aid of a Bragg-grating coupler.

FIGS. 7, 8, 9, 10 and 11 are a presentation of various technological sections of the device of the invention, respectively with an active optical element produced in the first SOI layer, an active optical element produced in the second SOI layer next to the electronic devices, an active optical element produced independently then put into a cavity, a coupler arranged in the optical layer and an active optical element put into a cavity made both in the electrical layer and in the lower layer, and a coupler arranged in the optical layer and an active optical element put into a cavity made in the layer below the electrical layer.

### DETAILED DESCRIPTION OF PARTICULAR EMBODIMENTS

The invention relates to a multilayer monolithic electronic device, which comprises an electronic circuit formed by at least one first layer capable of conveying information in an electrical form, arranged above an optical circuit comprising at least one layer capable of conveying information in an optical form, and means for electrical and/or optical connection between these two circuits.

The optical circuit is located underneath the electronic circuit, because the latter necessarily ends with an electrical layer for supplying the electrical power.

The method for producing such a device consists in producing optical guides, which may be of any type, in a first layer. This layer may also contain sources, detectors, amplifiers, modulators, filters, switches, etc., referred to as “active optical elements” in the description, or optical coupling means.

The light sources are, for example, light-emitting diodes or lasers, etc. The detectors may, for example, be photodiodes, photoconductors, phototransistors, etc. These elements may be further enhanced by photonic band gap structures. For example, the presence of mirrors around a photodiode reinforces the absorption of light by a resonance effect.

The assembly produced in this way is then assembled with a second layer, for example by molecular adhesion. This molecular adhesion step may optionally be preceded by a step of preparing the surfaces.

An assembly of the “multilayer” type is then obtained, in which the optical guides are included in the lower layer, and the traditional electronic components (MOS, bipolar, etc.) are produced in the upper layer.

Depending on the case, the active optical elements may be produced in the upper layer or in the lower layer, by using a technology compatible with the nature of the layers employed. In the case of a silicon substrate, for example, SOI layers are used and the active optical elements are made of Si, SiGe, erbium-doped Si, or silicon nanocrystals.

In the event that the active optical elements are not produced in the lower layer, and if the light has a direction different from that of the plane of the layers, coupling means produced in the lower layer are used to couple the light between the optical guides and the active optical elements. When the active optical elements cannot be integrated in the upper or lower layers, a holding cavity which can accommodate such a component may also be produced in the upper or lower layers. Such relocation is also possible above the upper layer.

Such relocations allow the combined use of active optical elements produced in a technology different from that of the substrate, for example with III-V or II-VI compounds.

Different attachment techniques are possible: for example vignetting or attaching a part of a layer, or by molecular adhesion.

The device of the invention includes optical inputs/outputs for the assembly produced in this way. These inputs/outputs may be of the lateral type or of the vertical type, for example by coupling with an optical fibre or by coupling via a microlens. Self-alignment of the fibres may also be provided, for example by using “V-grooves”.

Furthermore, the electrical and optical layers are not necessarily in direct contact: interlayers may be interposed between the two layers in order to support functions of, for example, optical and/or electrical insulation. In this case, the connection means will pass through them.

Various embodiments which demonstrate the characteristics of the device of the invention will now be considered as examples.

Optical Guides Produced in the Lower SOI Layer

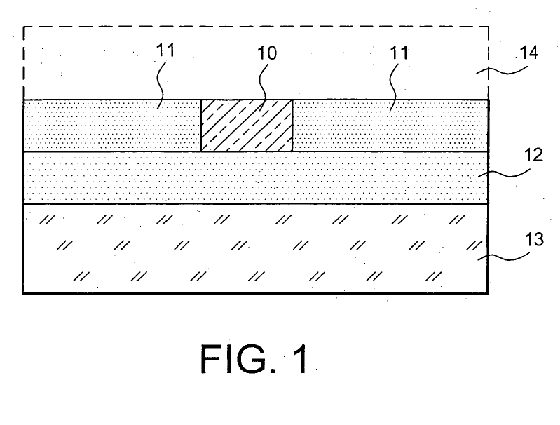

FIGS. 1, 2 and 3 present the optical guides after they have been produced and before the upper layer has been attached.

FIG. 1 illustrates a monocrystalline silicon guide 10 surrounded by two SiO₂ insulator regions 11, which are arranged on an SiO₂ insulator layer 12, and a silicon substrate 13.

The light propagates perpendicularly to the plane of the section in the guide 10. Preparation of the upper surface, optionally with deposition and/or polishing steps, may be necessary in order to allow the upper SOI layer 14 to be attached by molecular adhesion. The insulator SiO₂ may be replaced fully, or locally, by any material which has a refractive index different from that of silicon and is compatible with the fabrication methods being employed.

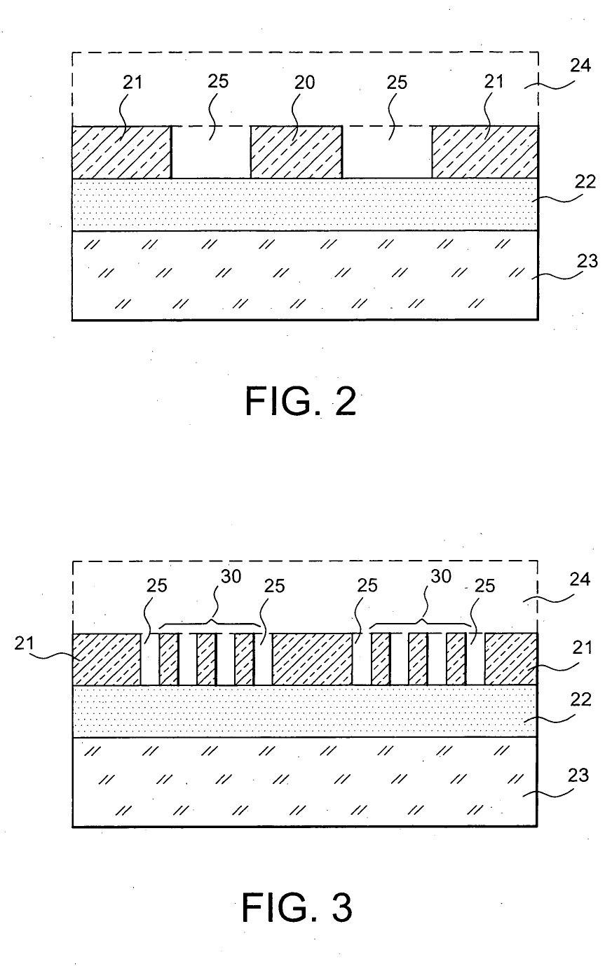

FIG. 2 illustrates a guide 20 and monocrystalline silicon patterns 21 which are obtained after etching in a monocrystalline silicon layer deposited on an SiO₂ layer 22 and a silicon substrate 23.

The light propagates perpendicularly to the plane of the section in the guide 20.

The patterns 21 fulfil functions of the mechanical pillar, or sealing, type and provide a surface capable of accommodating the upper SOI layer 24. This layer 24 can hence be attached to a so-called “patterned” layer. The spaces 25 between these patterns 21 and the guide 20 are filled with air, vacuum, inert gas or a material with a low refractive index such as SiO₂ or a polymer. These patterns 21 are directly linked with the attachment method and are not always indispensable.

FIG. 3 illustrates a monocrystalline silicon guide 30 based on forbidden photonic band gap (FPBG) structures.

This FIG. 3 also shows the elements illustrated in FIG. 2, except that the guide 20 has been defined by FPBG structures 30 filled with air, vacuum, inert gas or a material with a low refractive index.

The SOI layer 24 may here again be attached to a patterned structure.

Other materials may be employed, for instance III-V materials (AsGa, InP etc.).

Optical Coupling Means Produced in the Lower SOI Layer

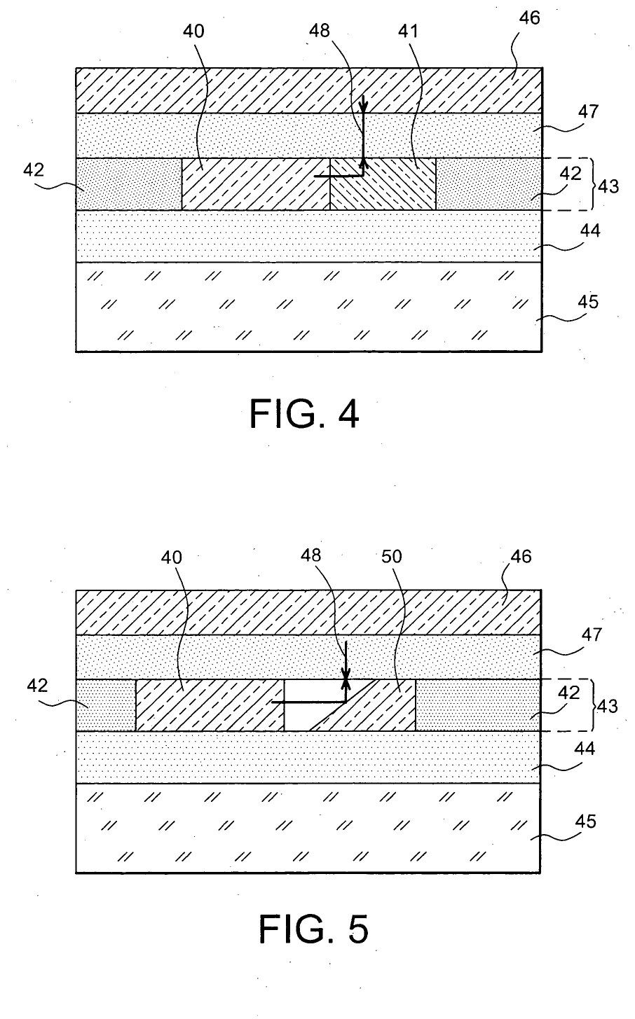

FIG. 4 illustrates a monocrystalline silicon guide 40 associated with a coupler 41, these being surrounded by two SiO₂ insulator regions 42 forming an optical layer 43 above an insulator layer 44 and a silicon substrate 45. A monocrystalline silicon electrical layer 46 is arranged above an SiO₂ insulator layer 47 and the optical layer 43.

The light 48 propagates parallel to the plane of the section in the optical guide 40 produced in the optical layer 43. This light 48 is coupled, between the guide 40 and a source/detector element (not shown) located in the upper layer, by a coupler 41. This coupler is of the horizontal/vertical type. All the materials and interfaces encountered along the optical path must ensure correct propagation of the light 48.

The coupler may be of various types: for example a reflection coupler 50 as illustrated in FIG. 5. This coupler 50 may then be made of silicon, optionally with a surface treatment.

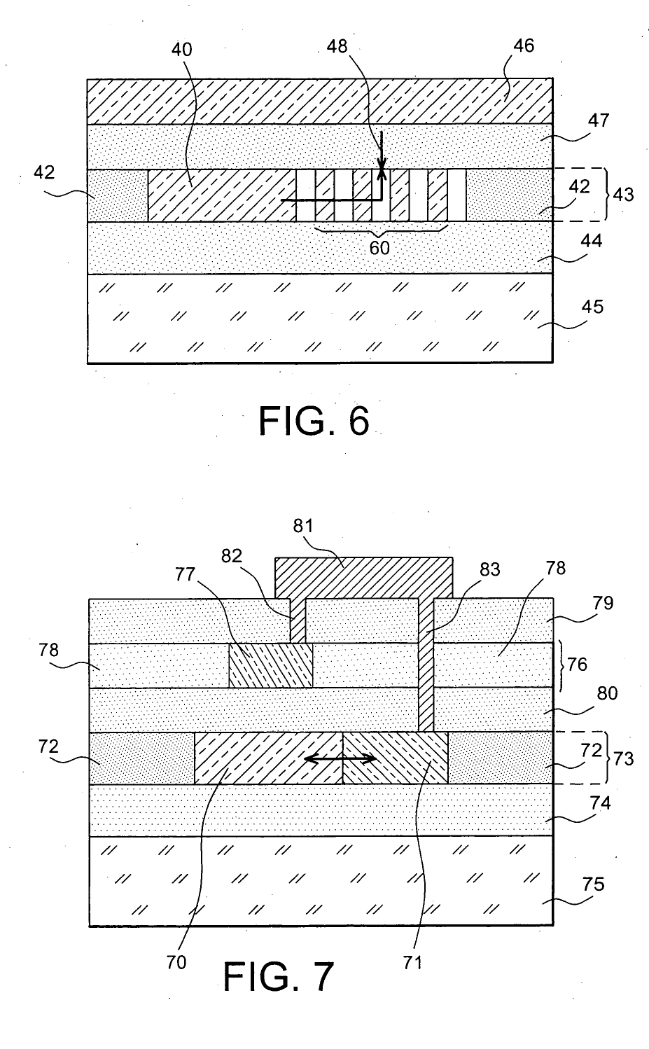

The coupler may be a Bragg-grating coupler 60, as illustrated in FIG. 6. This coupler 60 is based on a diffracting periodic structure. Using a network as described in the document referenced [2], or, more generally, a diffracting structure (for example a hole grating) then makes it possible for the light guided in the plane of the optical layer 43 to be redirected towards the vertical direction (and, reciprocally, from a direction out of the plane towards the axis of the guides).

Specifically, the document referenced [2] relates to coupling of light with high efficiency in a sub-micrometric SOI guide. As the coupling of light between a waveguide having a sub-micrometric thickness is conventionally carried out with the use of a grating coupler, this document envisages improving the efficiency by arranging a mirror above the grating.

Presentation of Various Possible Technological Sections

FIG. 7 illustrates an embodiment in which the guide 70 and the active optical elements 71 are produced in the optical layer 73.

The guide 70 and its associated active optical element 71, located between two SiO₂ insulator regions 72 so as to constitute the optical layer 73, are arranged above an SiO₂ insulator layer 74 and a silicon substrate 75.

The electrical layer 76, consisting of an MOS element 77 surrounded by two SiO₂ insulator regions 78, is arranged between an upper insulator layer 79 and a lower insulator layer 80, this lower layer 80 being arranged above the optical layer 73. A metal contact pad 81 arranged above the upper insulator layer 79 is connected by vertical metal connections 82 and 83, on the one hand to the MOS component 77 and, on the other hand, to the active optical element 71.

All these layers have thicknesses of between 0.1 and 1 μm.

The guides 70 and the active optical elements 71 are hence produced in the first SOI layer. The technologies employed are compatible with the rest of the method of the invention: that is to say the steps of attaching the second SOI layer, and of fabricating the electronic components in the upper SOI layer and the interconnects.

After preparing the surfaces (optional deposition, optional polishing, etc.) of this first SOI layer, the second SOI layer is attached to it by molecular adhesion, for example by using a method of the “smart cut” type. Depending on the nature of the optical components being used, this attachment may be carried out on a patterned first SOI layer. The electronic devices are then produced by using the conventional technological methods of an SOI technology: for example CMOS on SOI.

The electronic components and the active optical elements are then connected to the interconnect planes (first metal or plane of localized interconnects). Depending on the quality of the etching methods employed, an additional lithography level may be necessary in order to make the contacts with the active optical elements, since they are at a greater depth than the electronic components.

The various interconnect planes are then produced by standard microelectronics methods well-known to the person skilled in the art, corresponding to the technological generation being used.

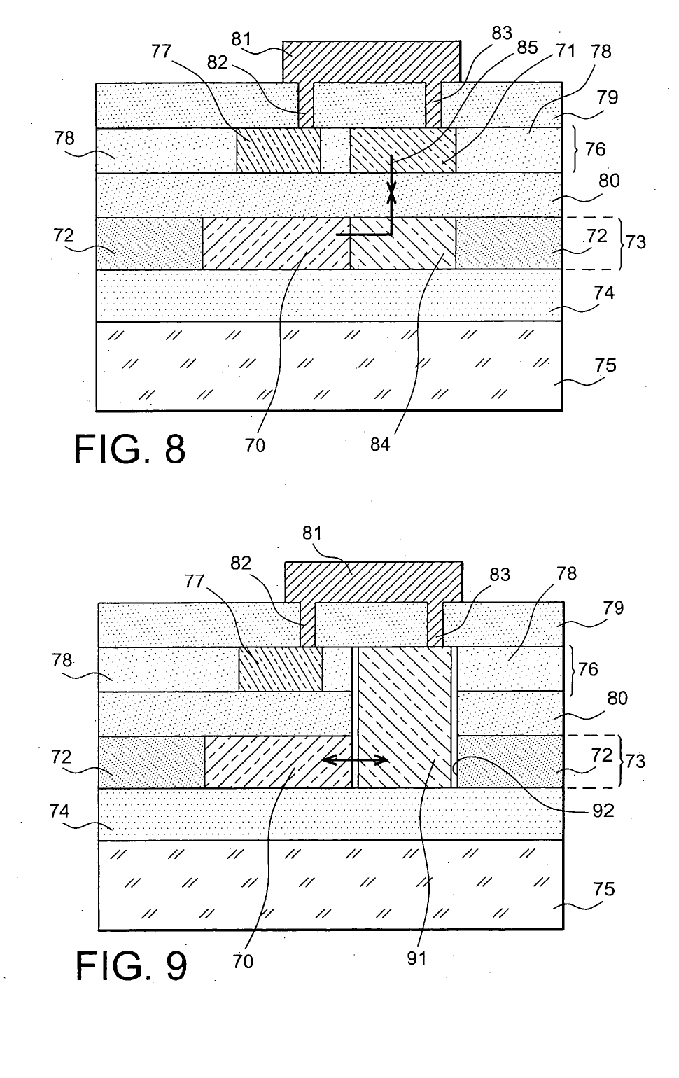

FIG. 8 illustrates an embodiment in which the active optical elements 71 are produced in the upper electrical layer 76, next to the electronic devices.

This embodiment involves the same elements as illustrated in FIG. 7, except that the active optical element 71 is moved onto the electrical layer 76, and it is replaced by a coupler 84 on the optical layer. An optical link 85 makes it possible to connect the guide 70 to the active optical element 71, through the coupler 84.

The guides 70 and the optical couplers 84 are produced in the first SOI layer. Here again, the technologies employed are compatible with the rest of the method: attaching the second SOI layer, and fabricating the electronic components, the active optical elements in the upper SOI layer and the interconnects.

After preparing the surfaces by optional deposition, optional polishing, etc., the second SOI layer is attached to the first SOI layer by molecular adhesion, for example by a method of the “smart cut” type. Depending on the nature of the optical components, this attachment may be carried out on a patterned layer.

The electronic components 77 are then produced by using the conventional technological methods of an SOI technology (for example CMOS on SOI). The active optical elements 71 are also produced in this upper SOI layer. The order in which the active optical elements 71 and the electronic components 77 are produced depends-on the optimization of the technological methods employed.

The interfaces between the various layers are optimized so that the quality of the optical transfer between the coupler 84 and the active optical element 71 is good.

The electronic components 77 and the active optical elements 71 are then connected to the interconnect planes (first metal or plane of localized interconnects). Depending on the quality of the etching methods employed, an additional lithography level may be necessary in order to make the contacts with the active optical elements 71.

All the interconnect planes are then produced by the standard microelectronics methods, corresponding to the technological generation being used.

FIG. 9 illustrates an embodiment in which the active optical elements are produced independently and then put in.

The elements illustrated in this FIG. 9 are the same as those illustrated in FIG. 8, apart from the active optical element 91 which is put into a cavity 92 extending between the optical layer 73 and the electrical layer 76.

The time at which to carry out these steps of producing a cavity 92 and of putting in the active optical element is optimized as a function of the thickness of the active optical elements to be put in: in the first SOI layer for very thin elements, or in the middle of the interconnect planes for thicker elements, the aim being to maintain a technological status which is as planarized as possible after these steps. All variants of cavity depth are possible (from 0 to a cavity penetrating into the lower substrate).

Once the cavities 92 have been produced, optoelectronic elements 91 which have been produced independently and whose nature may optionally be different from silicon (for example, AsGa, InAs, InAsP, InGaAsP, etc.) are put into them. This attachment may be carried out by techniques of vignetting or molecular adhesion.

The electronic components 77 and the active optical elements 91 are then connected to the interconnect planes (first metal or plane of localized interconnects). Depending on the quality of the etching methods employed, an additional lithography level may be necessary in order to make the contacts with the active optical elements 91. Furthermore, the contacts on the optical elements are not necessarily produced in the same way as the contacts on the electrical elements.

All the interconnect planes are then produced by the standard microelectronics methods, corresponding to the technological generation being used.

In the case illustrated in FIG. 9, the attached elements 91 naturally emit in the plane of the guides, and it is sufficient for them to be aligned correctly with it (in the case of rings or micro-discs, for example).

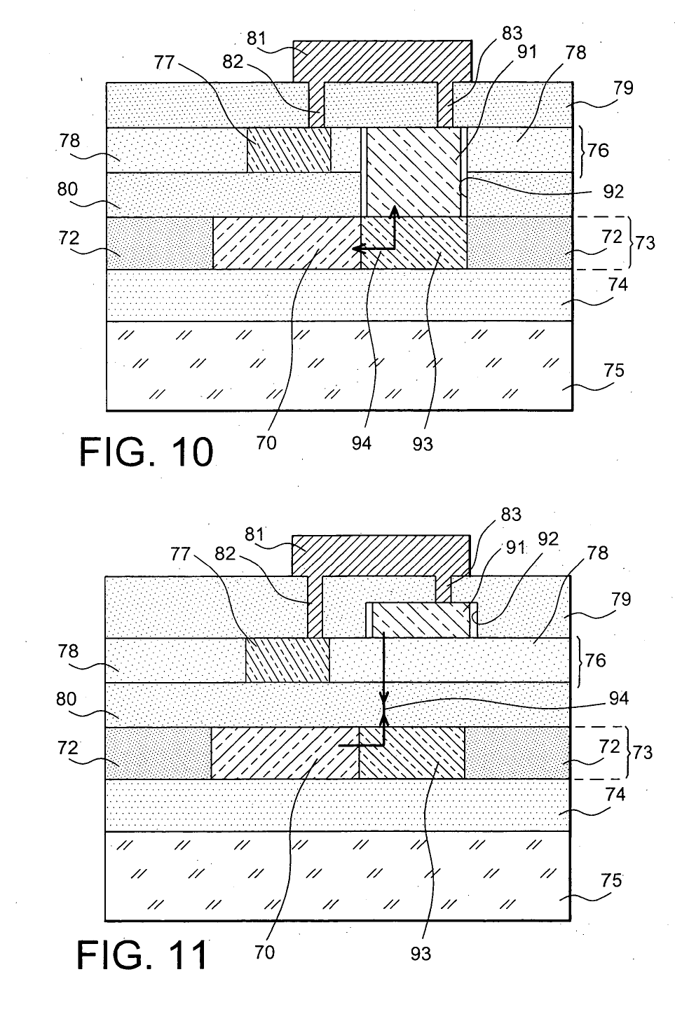

If the active optical element emits in a different direction, it is expedient to use other means for coupling the light 93 than those defined above. They will then be integrated in the optical layer 73. The active optical element 91 may then be arranged in a cavity 92 formed both in the electrical layer 76 and in the layer 80 below it, as illustrated in FIG. 10, or in the layer 79 above the electrical layer 76, as illustrated in FIG. 11.

All feasible combinations between the various embodiments described above are possible; an optical source element could correspond to one mode and an optical detector element could correspond to another mode.

Materials other than those considered above may be used, for instance:

in the optical layer, a pair of high-index/low-index materials is sufficient for producing a guide. Semiconductor materials may hence be used: Si/SiO₂, Si/Si₃N₄, InP/GaInP, GaAs/Ga/AlAs,

semiconductors other than SiGe may be used in the electrical layer.

### References

[1] “Optoelectronic interconnects for integrated circuits Achievements 1996-2000” by Henk Neefs. (Advanced research initiative in microelectronics, MEL-ARI OPTO, EEC, June 2000, pages 2-8).

[2] “High-efficiency light coupling in a submicrometric silicon-on-insulator waveguide” by Regis Orobtchouk, Abdelhalim Layadi, Hamid Gualous, Daniel Pascal, Alain Koster and Suzanne Laval (Applied Optics, Jan. 11, 2000, volume 39, No. 31, pages 5773-5777).

1. Multilayer monolithic electronic device comprising means for connection between at least two layers, which includes at least one first layer capable of conveying information in an electrical form, arranged above at least one second layer capable of conveying information in an optical form, and in that the connection means are electrical and/or optical means.

2. Device according to claim 1, in which the first layer capable of conveying information in an electrical form comprises at least one electronic component, and the second layer capable of conveying information in an optical form comprises at least one optical guide.

3. Device according to claim 1, in which one of the layers is made of a material selected from Si, AsGa, InP and their alloys.

4. Device according to claim 2, in which each optical guide is a high-index homogeneous region contained between lower-index regions.

5. Device according to claim 1, comprising patterns fulfilling functions of the mechanical pillar or sealing type and providing a surface capable of accommodating the upper layers.

6. Device according to claim 5, in which the spaces between the patterns and/or around the optical guide are filled with air, vacuum, inert gas or material with a low refractive index.

7. Device according to claim 2, in which each optical guide is a guide based on a photonic band gap structure which is filled with air, vacuum, inert gas or a material with a refractive index lower than that of the material guiding the light.

8. Device according to claim 1, in which the second layer capable of conveying information in an optical form comprises coupling means, and the first layer capable of conveying information in an electrical form comprises at least one active optical element, the coupling means making it possible to obtain coupling between at least one optical guide and at least one active optical element.

9. Device according to claim 8, in which the coupling means comprise a reflection coupler.

10. Device according to claim 8, in which the coupling means comprise a diffraction coupler.

11. Device according to claim 1, in which the second layer comprises at least one active optical element and the connection means are electrical means between this element and the first layer.

12. Device according to claim 1 having optical inputs/outputs.

13. Method for producing a multilayer monolithic electronic device, which includes the following steps:
producing at least one optical guide in a first layer,
assembling the silicon substrate thus covered with a second layer,
producing electronic components in the second layer.

14. Method according to claim 13, in which the assembling is carried out by molecular adhesion.

15. Method according to claim 13, which furthermore includes a step of fabricating at least one active optical element and/or optical coupling means in the first layer.

16. Method according to claim 13, which furthermore includes a step of fabricating at least one active optical element and/or optical coupling means in the second layer.

17. Method according to claim 13, in which the high-index region of the optical guide is obtained by etching.

18. Method according to claim 13, in which the low-index region of the optical guide is obtained by oxidation or nitriding.

19. Method according to claim 13, in which the difference between the optical indices of the optical guide is obtained by doping.

20. Method according to claim 13, in which at least one active optical element is put into a holding cavity.

21. Method according to claim 13, in which the layers are SOI layers attached to a silicon substrate.
